(19) United States
(12) Patent Application Publication
(10) Pub. No.: US 2006/0173667 A1
(43) Pub. Date: Aug. 3, 2006

(54) Simulation device for integrated circuit

(76) Inventor: Takashi Sumikawa, Ibaraki-shi (JP)

Correspondence Address: MCDERMOTT WILL & EMERY LLP, 600 13TH STREET, N.W., WASHINGTON, DC, 20005-3096, US

(21) Appl. No.: 11/341,652

(22) Filed: Jan. 30, 2006

(30) Foreign Application Priority Data
Jan. 31, 2005 (JP) 2005-023043

(51) Int. Cl. G06F 17/50

(52) U.S. Cl. 703/14

(57) ABSTRACT

A simulation device for an integrated circuit according to the present invention comprises a first memory unit, a first input unit, a second memory unit, an execute unit, a second input unit and an output unit. A net list of a particular path in inter-cell paths in the integrated circuit comprising a plurality of synchronizing circuit cells is stored in the first memory unit. The first input unit appends a variation information relating to gate lengths, gate widths and the like of transistors to the net list stored in the first memory unit. The variation net list to which the variation information is appended by the first input unit is stored in the second memory unit. The execute unit executes a simulation using the variation net list stored in the second memory unit to thereby calculate a delay variation distribution. The second input unit appends a circuit information to the path. The output unit sets and outputs a design margin of the circuit based on the delay variation distribution calculated by the execute unit and the circuit information appended by the second input unit.

### BACKGROUND OF THE INVENTION

1. Field of the Invention

The present invention relates to a simulation device for setting a design margin of a semiconductor integrated circuit and a method of designing an integrated circuit using the simulation.

2. Description of the Related Art

In a manufacturing process of an integrated circuit, manufacturing conditions unavoidably fluctuate, and the fluctuations generated in the manufacturing conditions have an effect on shapes and physical conditions of circuit elements, thereby generating variations in characteristics of the integrated circuit. Though a device length of a transistor tends to be reduced along with minimization in a rapid progress of the integrated circuit in order to improve a performance thereof, the minimization that is increasingly advanced (reduction of the device length of the transistor) adversely enlarges the fluctuations in the manufacturing conditions. Thus, the advancement of the minimization can be a barrier for homogenizing the characteristics of the integrated circuit. Therefore, it is important in the stages where the integrated circuit is developed and designed to perform a circuit simulation under consideration of the variations resulting from the manufacturing process to thereby verify operations of circuits and set the suitable design margin.

As a simulation method under consideration of the variations resulting from the manufacturing process the Monte Carlo simulation is often employed. The Monte Carlo simulation is a method in which the variations are replaced as random numbers by expressing as a probability so that a plurality of simulations can be performed, which is adopted when corner parameters used in the simulation are prepared and a correlation between the parameters are taken into account.

An example of the conventional statistical simulations is disclosed in No. H10-56167 of the Publication of the Unexamined Japanese Patent Applications. In the disclosed simulation, a plurality of sampling points obtained by combining a plurality of parameter values is set in a dispersed state, and an equation relating to semiconductor physics are thereby solved. According to the simulation, the characteristics of the integrated circuit at the respective sampling points are calculated, and a result of the calculation is compensated by means of the RSM (Response Surface Methodology) so that the characteristic at an arbitrarily sampling point is predicted.

Another example of the conventional statistical simulations is disclosed in No. 2002-305253 of the Publication of the Unexamined Japanese Patent Applications. In the simulation, values of ion implantation concentrations and values of gate lengths of N-type and P-type semiconductor devices are independently obtained, the simulation is performed and saturation current values are calculated, and the simulation parameters are extracted based on a distribution chart of the calculated saturation current values.

In the statistical simulations mentioned above, based on the much more minimization of the integrated circuit, it is desirable to set a timing design margin which allows the operation of the integrated circuit even when the variations resulting from the manufacturing process are at the worst level.

However, there are many types of the integrated circuit, and a cell structure differs in each of the types, which makes it difficult to set the design margin of the integrated circuit at one pattern.

### SUMMARY OF THE INVENTION

Therefore, a main object of the present invention is to analyze characteristics of a semiconductor integrated circuit and set a design margin thereof suitably.

The inventors of the present invention, in relation to a circuit simulation in which the design margin of the integrate circuit is set, studied the influences caused by circuits used for the simulation in detail.

For example, an integrated circuit shown in FIG. 12A and an integrated circuit shown in FIG. 2B have different cell structure respectively. FIG. 12A shows the circuit comprising the cells of a same type, while FIG. 12B shows the circuit comprising the cells of a plurality of types.

As a result of the study, it was founded out that there were variations generated due to layout shapes of the cells other than variations resulting from a manufacturing process between each cell. Therefore, change in the characteristics are increased when the cells of the plurality of types are combined to form the integrated circuit in comparison to the integrated circuit comprising the combined cells of the same type. The present invention provides the following structure based on the knowledge mentioned above.

Namely, in the present invention, in order to achieve the foregoing object, an information regarding the structure of the circuit is inputted in advance even though the circuit comprises the cells of the plurality of types. Below is given a more detailed description.

A simulation device for an integrated circuit according to the present invention comprises a first memory unit for storing a net list of a particular path among the paths between each cell in an integrated circuit comprising a plurality of synchronizing circuit cells, a first input unit for adding a variation information relating to gate lengths, gate widths and the like of transistors consisting of the synchronizing circuit cells to the net list stored in the first memory unit, a second memory unit for storing the variation net list to which the variation information is added by the first input unit, an execute unit for execute the simulation using the variation net list stored in the second memory unit and calculating a delay variation distribution, a second input unit for adding a circuit information to the path, and an output unit for setting and outputting a design margin of the circuit based on the delay variation distribution calculated by the execute unit and the circuit information added by the second input unit.

According to the foregoing structure, the design margin can be appropriately set according to the particular path among the paths between each cell, and the design margin can be more accurate since the circuit information corresponding to the path is inputted. Further, a relation between the design margin and the circuit information can be clarified, which improves a level of efficiency in designing the integrated circuit.

In the foregoing structure, there are several modes for the particular path as follows.

The particular path is a critical path having a largest delay among the paths between the synchronizing circuit paths, in which case the design margin can be optimized and set by targeting on the critical path.

The particular path is an arbitrary path in an actual circuit block, in which case, more preferably, when a path having a large delay variation is selected as the arbitrary path so that the design margin to be set can be prevented from resulting in an excess or underestimate and thereby is given at a high accuracy

The particular path is a plurality of arbitrary paths in the actual circuit block, in which case the design margin can be set under consideration of difference on the delay variations between the paths by selecting the plurality of arbitrary paths.

When the plurality of paths are selected, it is preferable that the output unit is set a value obtained by averaging value of design margin of the respective arbitrary paths as the design margin of the integrated circuit.

When the plurality of paths are selected, it is preferable that the output unit is set a maximum value among the values of the design margin of the respective arbitrary paths as the design margin of the integrated circuit.

It is preferable that a net list of a model circuit comprising cells of a plurality of types different to each other is stored into the first memory unit. In this case the design margin can be set at an early development stage when a sufficient amount of information relating to the paths of the integrated circuit is not yet obtained.

Further, in the foregoing structure comprising a third input unit for providing a delay variation distribution by actual measurements to the net list, it is preferable that the design margin can be set in comparison of the delay variation distribution calculated by the execution of the simulation with the delay variation distribution by the actual measurements, in which case the design margin can be more accurately set.

Further, it is preferable that the variation information relating to the gate lengths, gate widths and the like of the transistors be corrected so that the delay variation distribution obtained in the simulation is consistent with the delay variation distribution by the actual measurements, in which case the design margin can be even more accurately set.

It is preferable that the second input unit provides an arbitrary circuit information to the path, which is different from the circuit information relating to the path to which the simulation is executed, in which case the arbitrary information, instead of the information of the integrated circuit itself used for the simulation, is inputted as the path information so that the design margin can be set considering any influence from number of gates, fan-outs, wiring pitches and the like.

Flip-flop circuits are often used as the synchronizing circuit cells.

A method of designing the integrated circuit according to the present invention comprises a step of preparing a net list of the integrated circuit, a step of preparing a variation net list of the net list using a variation information relating to gate lengths, gate widths and the like of transistors consisting of the synchronizing circuit cells, and a step of designing the integrated circuit by calculating a delay variation distribution by the execution of a circuit simulation using the variation net list and setting a design margin using the calculated, delay variation distribution and a path information relating to the integrated circuit. According to the above procedure, the design margin can be more appropriately set than in the conventional technology because the path information used for setting the design margin is specified.

As so far described, according to the present invention, the design margin can be appropriately set corresponding to the different paths, and further, the design margin can be more accurate by inputting the circuit information. Further, the relation between the design margin and the circuit information can be clarified, which gives a large affect on the designing process of the integrated circuit.

The simulation device according to the present invention for setting the design margin in consideration of the path information of the integrated circuit is applied to the developments of an EDA (Electronic Design Automation) tool, a library of a standard cell and the like. It is useful in producing a high-performance semiconductor integrated circuit comprising a plurality of standard cells thus developed.

### BRIEF DESCRIPTION OF THE DRAWINGS

The other objects of the invention except the one mentioned above will become clear by the following description of preferred embodiments of the invention and being given as the claims attached. A number of benefits not recited in this specification will come to the attention of the skilled in the art upon practice of the present invention.

FIG. 1 is a block diagram illustrating a structure of a simulation device for an integrated circuit according to an embodiment 1 of the present invention.

FIG. 2 shows an input window of a transistor variation information input section according to the embodiment 1.

FIG. 3 shows a delay variation distribution in a simulation execute section according to the embodiment 1.

FIG. 4 shows an input window of a path information input section according to the embodiment 1.

FIG. 5 is a block diagram illustrating a structure of a simulation device for an integrated circuit according to an embodiment 2 of the present invention.

FIG. 6 is a block diagram illustrating a structure of a simulation device for an integrated circuit according to an embodiment 3 of the present invention.

FIG. 7 shows a delay variation distribution in a simulation execute section according to the embodiment 3.

FIG. 8 is a block diagram illustrating a structure of a simulation device for an integrated circuit according to an embodiment 4 of the present invention.

FIG. 9 is a block diagram illustrating a structure of a simulation device for an integrated circuit according to an embodiment 5 of the present invention.

FIG. 10 is a block diagram illustrating a structure of a simulation device for an integrated circuit according to an embodiment 6 of the present invention.

FIG. 11 is a flow chart of steps in a method of designing an integrated circuit according to an embodiment 7 of the present invention.

FIG. 12A shows a circuit comprising the same type of cells.

FIG. 12B shows a circuit comprising a plurality of types of cells.

### DETAILED DESCRIPTION OF THE INVENTION

Hereinafter, preferred embodiments of a simulation device for an integrated circuit according to the present invention are described referring to the accompanying rawings.

### Embodiment 1

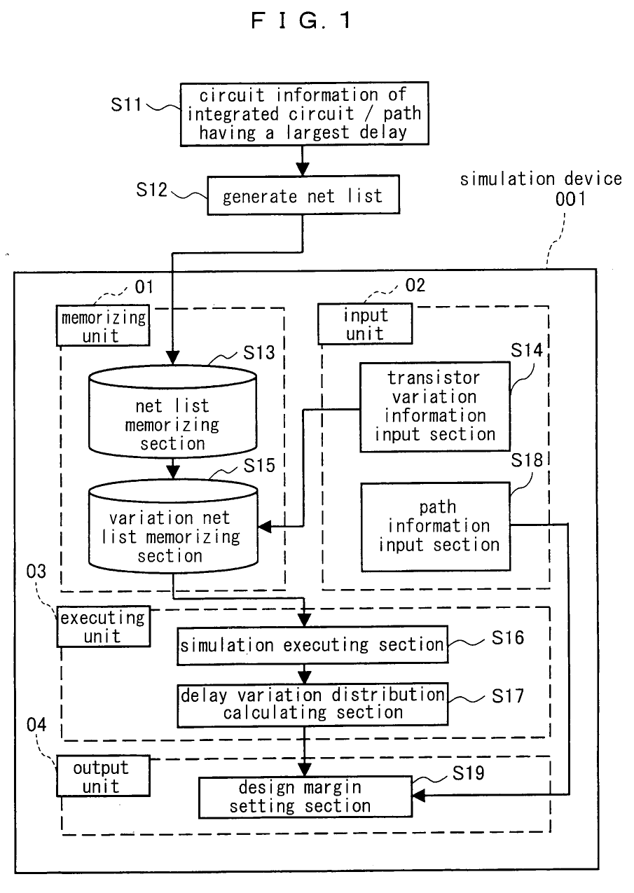

FIG. 1 is a block diagram illustrating a structure of a simulation device 001 for an integrated circuit according to an embodiment 1 of the present invention. The simulation device 001 comprises four components, which are a memory unit 01, an input unit 02, an execute unit 03 and an output unit 04. Below is described a method of simulating the integrated circuit using the simulation device 001.

First, a path having the largest delay, that is a critical path, is selected among the flip-flops of the circuit and the paths of the flip-flop circuits as an information of the integrated circuit to be inputted to the simulation device 001 (Step S11). Then, a net list of the path selected in the Step S11 is prepared (Step S12), and the prepared net list is stored in the memory unit 01 (Step S13), wherein an operation of the Step S13 is executed by a net list memory section of the memory unit 01. The net list memory section corresponds to the first memory unit according to the present invention.

Next, the net list stored in the memory unit 01 is retrieved. In the meantime, a variation information relating to gate lengths, gate width and the like of transistors is inputted to the input unit 02 (Step S14). an operation of the Step S14 is executed by a transistor variation information input section of the input unit 02. The transistor variation information input section corresponds to the first input unit according to the present invention. The variation information of the transistors is not limited to the gate length and gate widths thereof, and may include an oxide film thickness, internal resistance, internal capacity and the like.

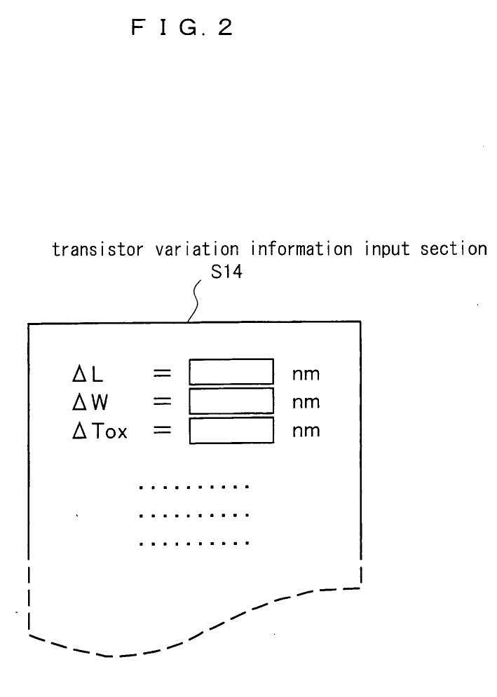

FIG. 2 shows an input window of the transistor variation information input section (S14) of the input unit 02 in the integrated circuit shown in FIG. 1. In the drawing, variation widths from central value are shown as ΔL, ΔW and ΔTox as an example in case of a gate length L, a gate width W and an oxide film thickness Tox of the transistor. Values of the respective variation widths are inputted to ΔL, ΔW and ΔTox.

The net list stored in the Step S13 and the transistor variation information inputted in the Step S14 are used so as to prepare a variation net list of the path. The variation net list of the path is added to the variation information relating to the gate lengths, gate widths and the like of the transistors. The prepared variation net list of the path is stored in the memory unit 01. An operation of the Step S15 is executed at a variation net list memory section of the memory unit 01. The variation net list memory section corresponds to the second memory unit according to the present invention.

Next, the execute unit 03 uses the variation net list of the path stored in the memory unit 01 to thereby execute a circuit simulation (Step S16). a delay variation distribution is further calculated at the execute unit 03 in the circuit simulation executed in the Step S16 (Step S17). An operation of the Steps S16 and S17 are executed by a simulation execute section (Step S16) and a delay variation distribution calculating section (Step S17) of the execute unit 03. The simulation execute sections and the delay variation distribution calculate section correspond to the execute unit according to the present invention.

A circuit information of the path is inputted to the input unit 02 (Step S18). An operation of the Step S18 is executed by a path information input section of the input unit 02. The path information input section corresponds to the second input unit according to the present invention.

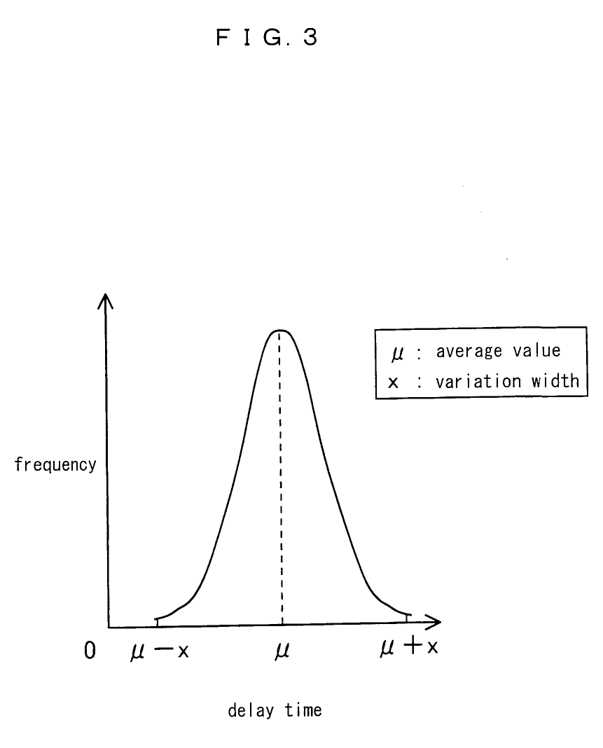

FIG. 3 shows the delay variation distribution at the execute unit 03 of the integrated circuit shown in FIG. 1. In the drawing, an average value of the delay variation is represented by μ, and a width of the delay variation is represented by x. A value of x can be set according to any standard, and may adopt a standard deviation value in the delay variation distribution.

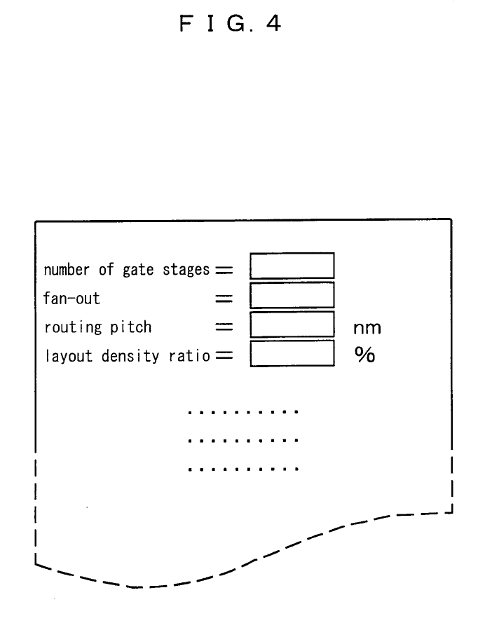

FIG. 4 shows an input window of-the path information input section (Step S18) of the input unit 02 of the integrated circuit shown in FIG. 1. In the drawing, number of gate stages, fan-outs, wiring pitches and a layout density ratio of the path are inputted. Variables for inputting the path information are not limited to the number of gate stages, fan-outs, routing pitches and layout density ratio, and may adopt a frequency of use about the cells in the circuit. The path information is based on the path selected in the Step S11 and, therefore, is determined by the path itself. When the path information is inputted, an effect given to the design margin by each variable can be expressed quantitatively. The input operation to the pass information input section may be executed by an operator of the simulation device 001 or may be automatically executed by the simulation device 001.

The design margin is set at the output unit 04 by means of the delay variation distribution calculated in the Step S17 and the path information inputted in the Step S18, and the set design margin is outputted from the output unit 04 (Step S19). The Step S19 is executed by a design margin setting section of the output unit 04. The design margin setting section corresponds to the output unit according to the present invention.

It is mentioned above that the design margin outputted in the Step S19 is calculated from the delay variation distribution, however, may be calculated from the delay variation distribution to which a power-supply voltage and a temperature variation distribution are added.

According the embodiment 1, the design margin can be set to optimize according to the critical path which is a particular path among the paths between each of cell, and a high accuracy of the design margin can be achieved by the input of the circuit information corresponding to the path. Further, a relation between the design margin and the circuit information can be clarified, which improves a level of efficiency in designing the integrated circuit.

### Embodiment 2

Next, a simulation device 002 for an integrated circuit according to an embodiment 2 of the present invention is described. In the embodiment 1, the critical path having the largest delay in the paths between the flip-flop circuits is used as the information of the integrated circuit used for the simulation. In contrast to the embodiment 1, a net list of an arbitrary path in an actual circuit block is used in the embodiment 2, wherein the design margin can be set in view of any influence from the path on the delay variation.

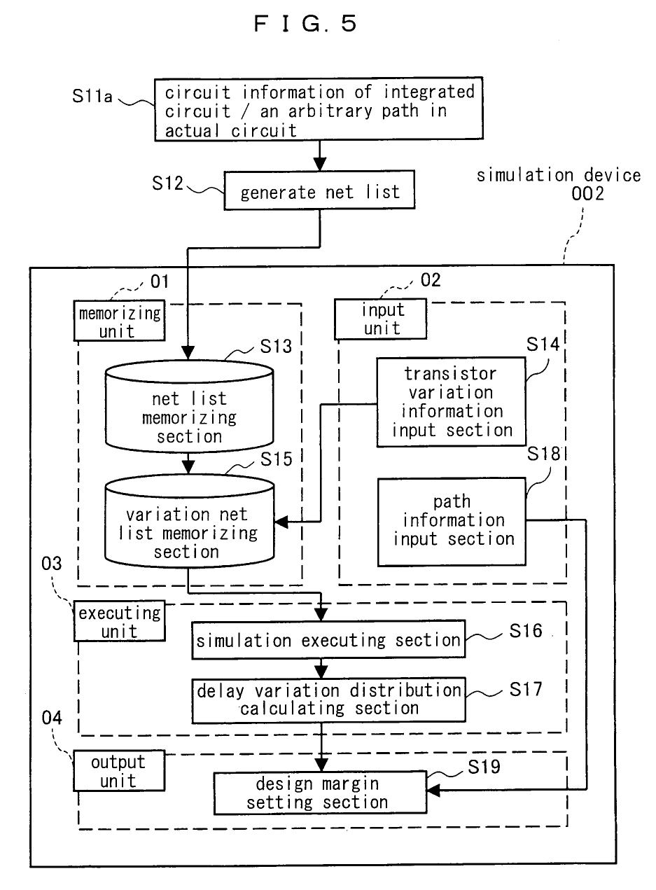

FIG. 5 is a block diagram illustrating a structure of the simulation device 002 for the integrated circuit according to the embodiment 2. The reference numerals shown in FIG. 5 are identical to those shown in FIG. 1 (embodiment 1), and the same reference numerals denote the same components. Any component described in the embodiment 1 is not described in the present embodiment again. Below is described a feature on structure of the embodiment 2.

An arbitrary path is selected from the actual circuit block as an information to be inputted to the simulation device 002 (Step S11a). A path having a large delay variation is optimally selected as the arbitrary path in the actual circuit block. Thereby, the design margin to be set can be prevented from resulting in excess or underestimate and thereby attain a high accuracy.

### Embodiment 3

Next, a simulation device 003 for an integrated circuit according to an embodiment 3 of the present invention is described. In the embodiment 2, an arbitrary path in the actual circuit block is used as the information of the integrated circuit used in the simulation. In contrast to the embodiment 2, net lists of a plurality of arbitrary paths in the actual circuit block are used in the embodiment 3 so that the design margin can be set up in view of any influence from the plurality of paths on the delay variation.

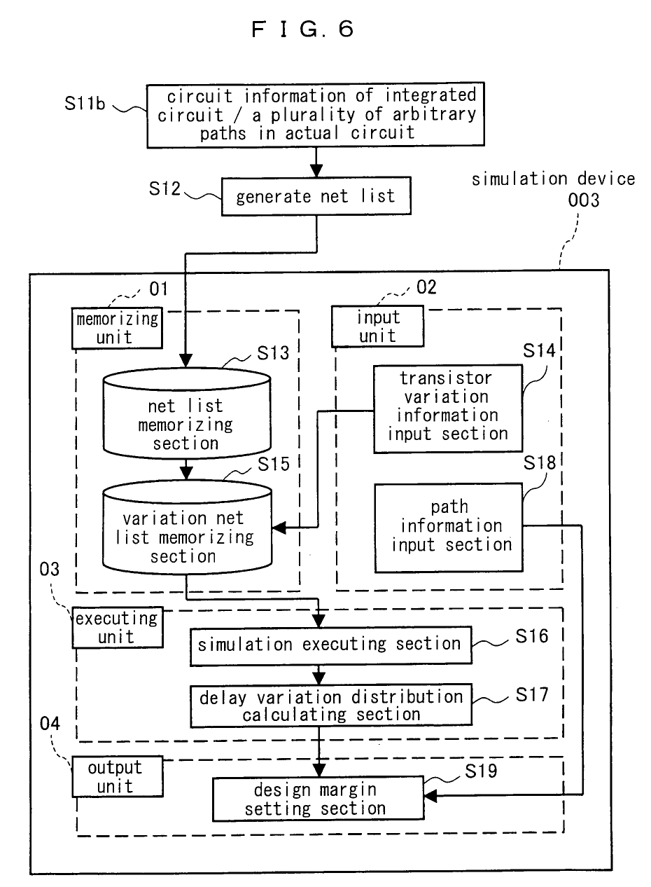

FIG. 6 is a block diagram illustrating a structure of the simulation device 003 for the integrated circuit according to the embodiment 3. The reference numerals shown in FIG. 6 are identical to those shown in FIG. 1 (embodiment 1), and the same reference numerals denote the same components. Any component described in the embodiment 1 is not described in the present embodiment again. Below is described a feature on structure of the embodiment 3.

The plurality of arbitrary paths in the actual circuit block is selected as an information of the integrated circuit to be inputted to the simulation device 003 (Step S11b).

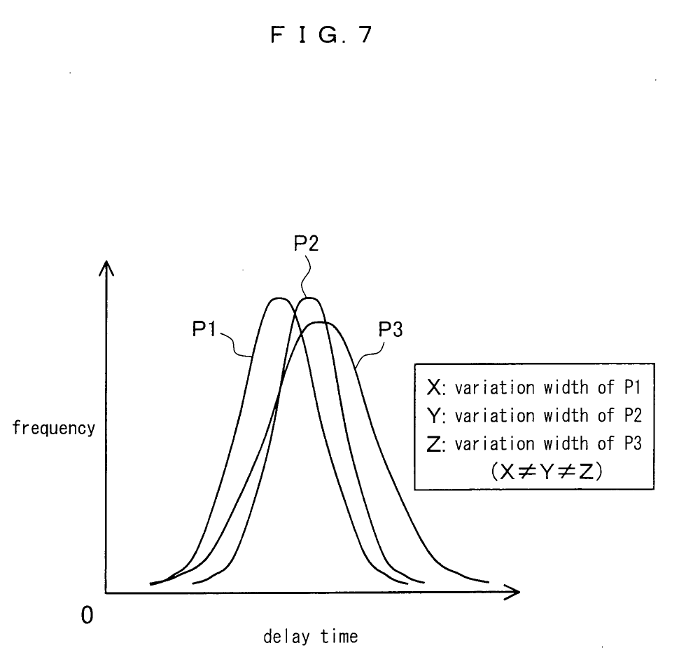

FIG. 7 shows a curve of a delay variation distribution in an execute unit 03 of the integrated circuit shown in FIG. 6. The drawing shows a curve of delay variation distributions in paths P1, P2 and P3 respectively. Widths of the delay variations in P1, P2 and P3 are respectively set to X, Y and Z (X≠Y≠X). X, Y and Z are set according to a same standard, and the number of the paths is not limited. When the design margin is set in the output unit 04, differences in the delay variations of the paths may be averaged to use, or the largest value in the delay variations of the paths may be used.

According to the embodiment 3, the plurality of arbitrary paths in the actual circuit block is selected so that the design margin can be set in view of the differences in the delay variations of the paths.

### Embodiment 4

Next, a simulation device 004 for an integrated circuit according to an embodiment 4 of the present invention is described. In the embodiment 3, the plurality of arbitrary paths in the actual circuit block is used as the information of the integrated circuit used in the simulation. In contrast to the embodiment 3, the design margin is set by use of a model circuit comprising a plurality of types of cell different to each other in the embodiment 4.

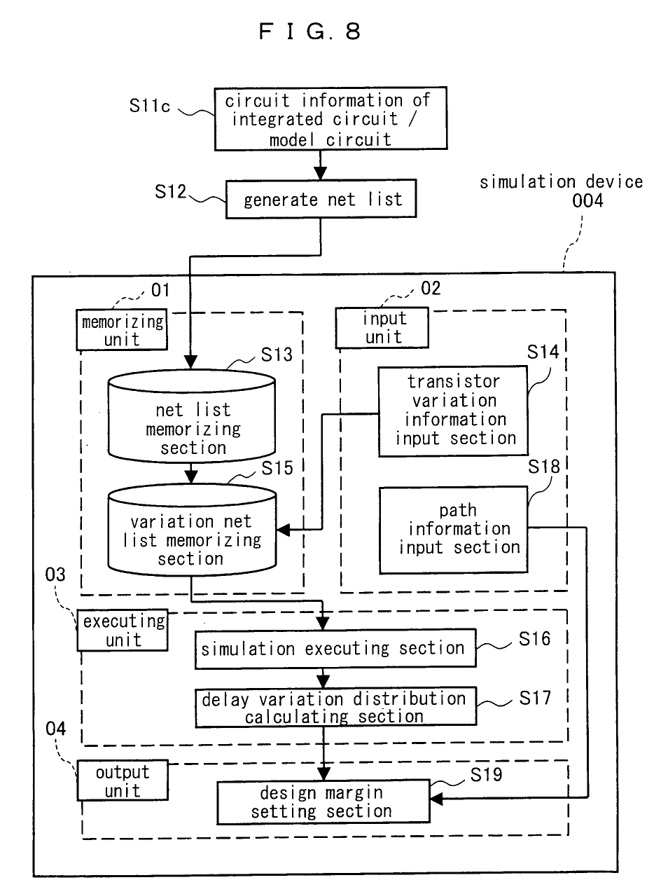

FIG. 8 is a block diagram illustrating a structure of the simulation device 004 for the integrated circuit according to the embodiment 4. The reference numerals shown in FIG. 8 are identical to those shown in FIG. 1 (embodiment 1), and the same reference numerals denote the same components. Any component described in the embodiment 1 is not described in the present embodiment again. Below is described a feature on structure of the embodiment 4.

The model circuit comprising a plurality of types of cell different to each other is selected as an information of the integrated circuit to be inputted to the simulation device 004 (Step S11).

According to the embodiment 4, the design margin can be set in an early development stage when a sufficient amount of information relating to the paths of the integrated circuit is not yet obtained.

### Embodiment 5

Next, a simulation device 005 for an integrated circuit according to an embodiment 5 of the present invention is described. In the embodiment 4, the model circuit comprising a plurality of types of cell different to each other is selected as the information of the integrated circuit used in the simulation. In contrast to the embodiment 4, the design margin is set by the comparison of the delay variation distribution calculated in the simulation to a delay variation distribution in actual measurements each other in the embodiment 5.

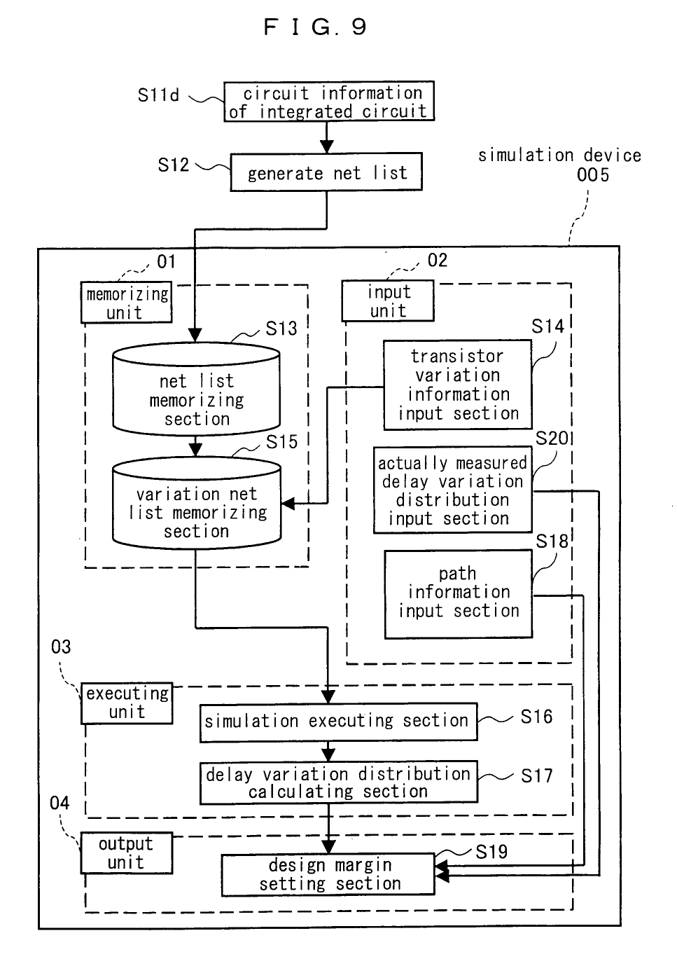

FIG. 9 is a block diagram illustrating a structure of the simulation device 005 for the integrated circuit according to the embodiment 5. The reference numerals shown in FIG. 9 are identical to those shown in FIG. 1 (embodiment 1), and the same reference numerals denote the same components. Any component described in the embodiment 1 is not described in the present embodiment again. Below is described a feature on structure of the embodiment 5.

The delay variation distribution obtained in the actual measurements of the paths in the integrated circuit is inputted to the input unit 02 (Step S20). The Step S20 is executed by a delay variation distribution input section measured practically of the input unit 02. The delay variation distribution input section measured actually corresponds to the third input unit according to the present invention.

The delay variation distribution in the simulation calculated in the Step S17, the delay variation distribution obtained in the actual measurements in the Step S20, and the path information inputted in the Step S18 are used so that the design margin is set, and the set design margin is outputted to the output unit 04 (Step S19). In the output unit 04, the delay variation distribution calculated in the simulation and the delay variation distribution obtained in the actual measurements are compared to each other, and then, the design margin is set in view of margin of error between the delay variations obtained in the simulation and the actual measurements.

Apart from the above structure, the information to be inputted to the input unit 02 may be corrected to set the design margin may so that the delay variation distribution calculated in the simulation and the delay variation distribution obtained in the actual measurements is consistent with each other. The information mentioned above includes the information relating to the gate lengths, gate widths and the like of the transistors.

According to the present embodiment, the design margin can be more accurately set up.

### Embodiment 6

Next, a simulation device 006 for an integrated circuit according to an embodiment 6 of the present invention is described. In the embodiments 1-5 described so far, the information of the integrated circuit itself used in the simulation is used as the path information of the integrated circuit used in the simulation. In contrast to those embodiments, an arbitrary path information is inputted in the embodiment 6.

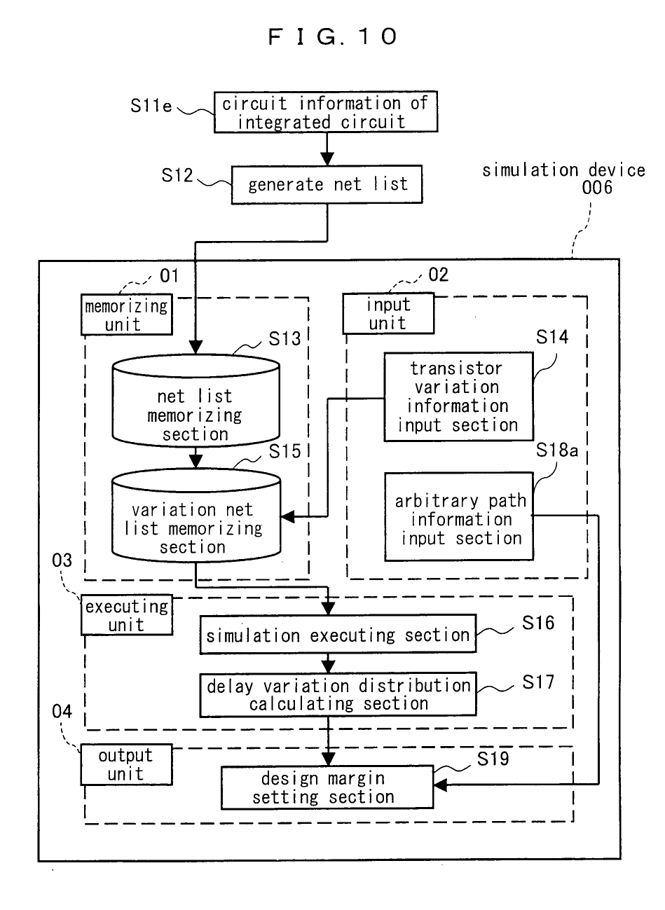

FIG. 10 is a block diagram illustrating a structure of the simulation device 006 for the integrated circuit according to the embodiment 6. The reference numerals shown in FIG. 10 are identical to those shown in FIG. 1 (embodiment 1), and the same reference numerals denote the same components. Any component described in the embodiment 1 is not described in the present embodiment again. Below is described a feature on structure of the embodiment 6.

In the embodiment 6, in Step S18a corresponding to the Step S18 described earlier, the arbitrary path information is inputted to the input unit 02. The Step S18a is executed by an arbitrary path information input section of the input unit 02. The arbitrary path information input section corresponds to the second input unit according to the present invention.

Accordingly, the design margin is set in view of the influences from the number of the gate stages, fan-outs, wiring pitches and the like shown in FIG. 4 in the embodiment 6 in comparison to the embodiments 1-5 wherein the information of the integrated circuit itself used in the simulation is inputted as the path information.

### Embodiment 7

Next, a method of designing the integrated circuit according to an embodiment 7 of the present invention is described. In the embodiments 1-6, the simulation device for the integrated circuit for setting the design margin is described. In the embodiment 7, the design margin is used for designing the integrated circuit.

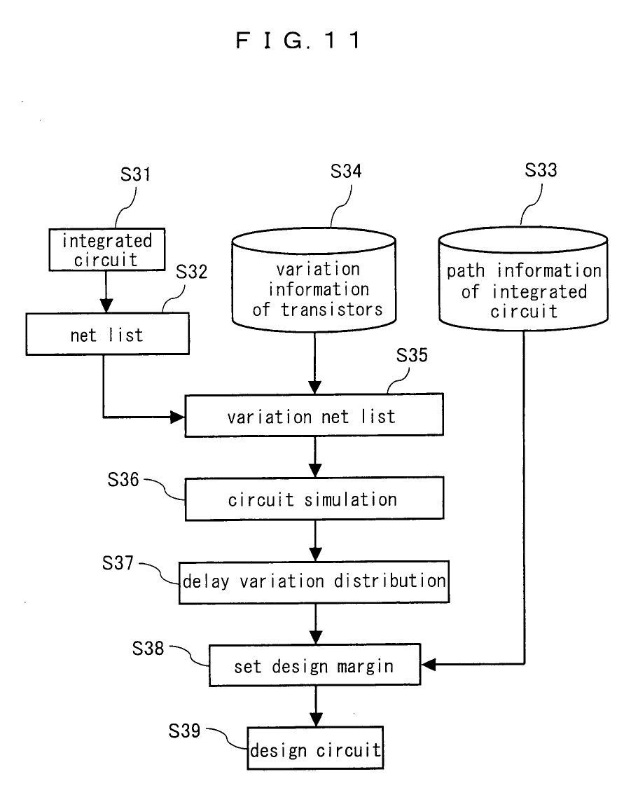

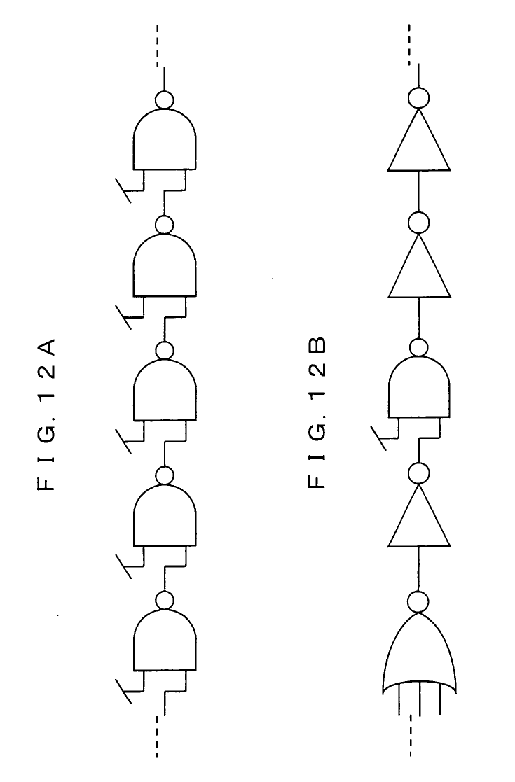

FIG. 11 is a flow chart of steps in the method of designing the integrated circuit according to the embodiment 7. First, the circuits used for designing the integrated circuit are prepared (Step S31), the net list of the integrated circuit is made (Step S32), and a database of the path information relating to the integrated circuit is made (Step S33). The path information includes the number of the gate stages, fan-outs, wiring pitches and the like.

Further, a database of the variation information relating to the gate lengths, gate widths and the like of the transistors is prepared (Step S34). The variation information of the transistors is not limited to the gate lengths and gate widths, and allows the oxide film thickness, internal resistances, internal capacity and the like to be used.

Next, the variation net list is made by use of the net list prepared in the Step S32 and the database of the variation information relating to the gate lengths, gate widths and the like of the transistors prepared in the Step S34 (Step S35). Next, the circuit simulation is performed based on the variation net list prepared in the Step S35 (Step S36). Next, the delay variation distribution is obtained from a result of the simulation (Step S37). Then, the database of the path information generated in the Step S33 and the delay variation distribution obtained in the Step S37 are used to set the design margin (Step S38). Finally, the design margin set in the Step S38 is used to design the integrated circuit (Step S39).

In the designing process in the Step S39, provided that the value of the outputted design margin is A, and a value of a frequency targeted for the operation of the integrated circuit is F[Hz], a timing design of the integrated circuit is made so that the operation is allowed at A×F[Hz]. The design margin set in the Step S38 is applied to not only to the operation frequency of the integrated circuit but also to such performance indices as power consumption and area.

According to the present embodiment, the design margin can be more suitably set up than in the conventional technology because the path information used in setting the design margin can be specified.

Though this invention has been described in detail with the examples as recited above, combination and arrangement of the parts in the preferred embodiments are not limited to the one mentioned here. It should be naturally understood that various modifications may be made therein, and it is intended to cover all such modifications in the appended claims as fall within the true spirit and scope of this invention.

What is claimed is:

1. A simulation device for an integrated circuit comprising:
a first memory unit for storing a net list of a particular path among the paths between each of cell in an integrated circuit having a plurality of synchronizing circuit cells;
a first input unit for adding a variation information relating to gate lengths, gate widths and the like of transistors consisting of the synchronizing circuit cells to the net list stored in the first memory unit;
a second memory unit for storing the variation net list to which the variation information is added by the first input unit;
an execute unit for executing a simulation using the variation net list stored in the second memory unit and calculating a delay variation distribution;
a second input unit for providing a circuit information to the path; and
an output unit for setting and outputting a design margin of the circuit based on the delay variation distribution calculated by the execute unit and the circuit information providing by the second input unit.

2. The simulation device for an integrated circuit according to claim 1, wherein
the particular path is a critical path having the largest delay among the paths between the synchronizing circuits.

3. The simulation device for an integrated circuit according to claim 1, wherein
the particular path is an arbitrary path in an actual circuit block.

4. The simulation device for an integrated circuit according to claim 1, wherein
the particular path is a path having a large delay variation.

5. The simulation device for an integrated circuit according to claim 1, wherein
the particular path is a plurality of arbitrary paths in an actual circuit block.

6. The simulation device for an integrated circuit according to claim 5, wherein
the output unit is set up to give a value obtained by averaging values of design margins of the respective arbitrary paths as the design margin of the integrated circuit.

7. The simulation device for an integrated circuit according to claim 5, wherein
the output unit is set up to give a maximum value among the values of design margins of the respective arbitrary paths as the design margin of the integrated circuit.

8. The simulation device for an integrated circuit according to claim 1, wherein
a net list of a model circuit comprising a plurality of types of cell different to each other is stored in the first memory unit.

9. The simulation device for an integrated circuit according to claim 1, further comprising,
a third input unit for providing a delay variation distribution obtained by actual measurements to the net list, wherein
the delay variation distribution calculated by the execution of the simulation and the delay variation distribution obtained by the actual measurements are compared to thereby set the design margin in the output unit.

10. The simulation device for an integrated circuit according to claim 9, wherein
the variation information relating to the gate lengths, gate widths and the like of the transistors is corrected so that the delay variation distribution obtained in the simulation is consistent with the delay variation distribution obtained by the actual measurements.

11. The simulation device for an integrated circuit according to claim 1, wherein
the second input unit provides an arbitrary circuit information to the path, which is different to the circuit information relating to the path to which the simulation is executed.

12. The simulation device for an integrated circuit according to claim 1, wherein
flip-flop circuits are used as the synchronizing circuit cells.

13. A simulation method for an integrated circuit comprising:
a first memory step for storing a net list of a particular path among the paths between each of cell in an integrated circuit comprising a plurality of synchronizing circuit cells;
a first input step for adding a variation information relating to gate lengths, gate widths and the like of transistors consisting of the synchronizing circuit cells to the net list stored in the first memory step;
a second memory step for storing the variation net list to which the variation information is provided by the first input step;
an execute step for executing a simulation using the variation net list stored in the second memory step and calculating a delay variation distribution;
a second input step for appending a circuit information to the path; and
an output step for setting and outputting a design margin of the circuit based on the delay variation distribution calculated in the execute step and the circuit information provided in the second input step.

14. The simulation method for an integrated circuit according to claim 13, wherein
the particular path is a critical path having the largest delay among the paths between the respective synchronizing circuits.

15. The simulation method for an integrated circuit according to claim 13, wherein
the particular path is an arbitrary path in an actual circuit block.

16. The simulation method for an integrated circuit according to claim 15, wherein
the particular path is a path having a large delay variation.

17. The simulation method for an integrated circuit according to claim 13, wherein
the particular path is a plurality of arbitrary paths in an actual circuit block.

18. The simulation method for an integrated circuit according to claim 17, wherein
a value obtained by averaging values of design margins of the respective arbitrary paths is set as the design margin of the integrated circuit in the output step.

19. The simulation method for an integrated circuit according to claim 17, wherein
a maximum value among the values of design margins of the-respective arbitrary paths is set as the design margin of the integrated circuit in the output unit.

20. The simulation method for an integrated circuit according to claim 13, wherein
a net list of a model circuit comprising a plurality of types of cell different to each other is stored in the first memory step.

21. The simulation method for an integrated circuit according to claim 13, further comprising,
a third input step for inputting a delay variation distribution obtained by actual measurements, wherein
the design margin is set by comparing the delay variation distribution calculated by the execution of the simulation to the delay variation distribution obtained by the actual measurements in the output step.

22. The simulation method for an integrated circuit according to claim 21, wherein
the variation information relating to the gate lengths, gate widths and the like of the transistors is corrected so that the delay variation distribution obtained in the simulation is consistent with the delay variation distribution obtained by the actual measurements.

23. The simulation method for an integrated circuit according to claim 13, wherein
an arbitrary circuit information, which is different to the circuit information relating to the path to which the simulation is executed, is provided to the path in the second input step.

24. The simulation method for an integrated circuit according to claim 13, wherein
the flip-flop circuits are used as the synchronizing circuit cells.

25. A method of designing an integrated circuit comprising a plurality of synchronizing circuit cells including:
a step of preparing a net list of the integrated circuit;
a step of preparing a variation net list of the net list using a variation information relating to gate lengths, gate widths and the like of transistors consisting of the synchronizing circuit cells; and
a step of designing the integrated circuit by calculating a delay variation distribution by execution of a circuit simulation using the variation net list and setting a design margin based on the calculated delay variation distribution and a path information relating to the integrated circuit.
